(19) United States
(12) Patent Application Publication
(10) Pub. No.: US 2026/0085560 A1
(43) Pub. Date: Mar. 26, 2026

(54) REMOVABLE DOOR LOCK-DOWN DEVICE

(71) Applicant: Scott W. Levandowski, Glendale, AZ (US)

(72) Inventor: Scott W. Levandowski, Glendale, AZ (US)

(21) Appl. No.: 18/893,712

(22) Filed: Sep. 23, 2024

Related U.S. Application Data
(63) Continuation-in-part of application No. 29/964,389, filed on Sep. 23, 2024, now Pat. No. D1068440.

(51) Int. Cl. E05C 19/18

(52) U.S. Cl. CPC E05C 19/188

(57) ABSTRACT

A removable lockdown device configured to prevent a set of double doors from opening. The removable lock down device includes a body including a top edge and a bottom edge. A first stepped arm and a second stepped arm are also included. The first and second stepped arms extend from opposing ends of the bottom edge, respectively, each stepped arm having a first section extending laterally outward from the body, and a second section extending downwardly from a distal end of the first section.

### RELATED APPLICATION

This application claims priority to and the benefit of U.S. design patent application 29/964389, filed Sep. 23, 2024, titled “DOOR LOCK-DOWN DEVICE,” the entirety of the disclosure of which is hereby incorporated by this reference.

### TECHNICAL FIELD

This disclosure relates generally to double door safety systems, and more particularly to a removable double door lockdown system including a lockdown device that secures doors as typically found in schools, stadiums, movie theaters, assembly areas, and other public facilities.

### BACKGROUND

A long-standing focus of safety codes for building, fire and lifesaving has typically been on providing safe egress in the event of a fire. More recently, in light of active shooter situations within school settings, the need to prevent unauthorized ingress through classroom doors is of utmost importance for protecting students and teachers in the classroom. Accordingly, there are now two priorities to ensure the safety of staff and students; safe and rapid egress, and preventing unauthorized ingress. In the event of an active shooter attempting to enter a school, it may be necessary to make a quick decision as to which response provides the highest level of safety for students; rapid egress, preventing unauthorized access, or a combination of both. Both of these needs—safe, easy and fast egress and preventing unauthorized ingress—must be considered.

### SUMMARY

In one aspect, a double door lockdown system is disclosed that includes a set of double doors and a removable lockdown device. Each door of the set of double doors has a door handle disposed on an outside thereof. A first exit device is disposed horizontally across a first door of the set, and a second exit device disposed horizontally across a second door of the set.

The first and second exit devices are disposed on an inside of the first and the second doors, respectively. The removable lockdown device is configured to prevent the set of double doors from opening. The removable lockdown device includes a body including a top edge and a bottom edge. A first stepped arm and a second stepped arm extend from opposing ends of the bottom edge, respectively. Each stepped arm has a first section extending laterally outward from the body, and a second section extending downwardly from a distal end of the first section. The body extends between the first exit device and the second exit device with the first section of the first stepped arm removably positioned atop the first exit device, the second section of the first stepped arm removably positioned between the first exit device and the inside of the first door, the first section of the second stepped arm removably positioned atop the second exit device, and the second section of the second stepped arm removably positioned between the second exit device and the inside of the second door.

Implementations may include one or more or all of the following.

Further including a fixed or removable mullion disposed between the double doors.

The first and second exit devices include any one of a panic bar, a push bar, a touch bar, or a crash bar.

The first stepped arm and the second stepped arm extend from opposing ends of the bottom edge perpendicular to the body.

Further including at least one handle disposed along at least a portion of the top edge of the body. The at least one handle has a curvilinear or rectilinear shape in cross-section.

The body, the first stepped arm, and the second stepped arm are a single piece.

In another aspect, a removable lockdown device is disclosed configured to prevent a set of double doors from opening. The removable lockdown device includes a body including a top edge and a bottom edge, the top edge including at least one handle disposed along at least a portion of the top edge. Also included is a first stepped arm and a second stepped arm. The first and second stepped arms extend from opposing ends of the bottom edge, respectively, each stepped arm having a first section extending laterally outward from the body, and a second section extending downwardly from a distal end of the first section.

Implementations may include one or more or all of the following.

The first stepped arm and the second stepped arm extend from opposing ends of the bottom edge perpendicular to the body.

The at least one handle has a curvilinear or rectilinear shape in cross-section.

The at least one handle includes a c-channel handle extending from the top edge in a direction opposite the first and second stepped arms.

The at least one handle includes a flat handle extending from the top edge in a direction opposite the first and second stepped arms.

The body, the first stepped arm, and the second stepped arm are a single piece.

In yet another aspect, a removable lockdown device is disclosed configured to prevent a set of double doors from opening. The removable lock down device includes a body including a top edge and a bottom edge. A first stepped arm and a second stepped arm are also included. The first and second stepped arms extend from opposing ends of the bottom edge, respectively, each stepped arm having a first section extending laterally outward from the body, and a second section extending downwardly from a distal end of the first section.

Implementations may include one or more or all of the following.

The first stepped arm and the second stepped arm extend from opposing ends of the bottom edge perpendicular to the body.

Further including at least one handle disposed along at least a portion of the top edge of the body. The at least one handle has a curvilinear or rectilinear shape in cross-section. The at least one handle includes a c-channel handle extending from the top edge in a direction opposite the first and second stepped arms. The at least one handle includes a flat handle extending from the top edge in a direction opposite the first and second stepped arms.

The body, the first stepped arm, and the second stepped arm are a single piece.

The foregoing and other aspects, features, and advantages will be apparent from the description, drawings, and/or from the claims.

### BRIEF DESCRIPTION OF THE DRAWINGS

Implementations will hereinafter be described in conjunction with the appended and/or included DRAWINGS, where like designations denote like elements, and:

FIG. 1 is a representation of a removable lockdown device comprising a c channel handle from a front perspective view;

FIG. 2 is a representation of the removable lockdown device of FIG. 1 from a back perspective view;

FIG. 3 is a representation of the removable lockdown device of FIG. 1 showing a left side cross section view;

FIGS. 4A and 4B are representations of a removable lockdown device comprising another implementation of a c channel handle;

FIG. 5 is a representation of a removable lockdown device comprising perforations disposed across the device;

FIG. 6 is a representation of a removable lockdown device comprising handles formed across side edges of the device;

FIG. 7 is a representation of the removable lockdown device of FIG. 1 being installed or removed as part of a removable door lockdown system;

FIG. 8 is a representation of the double door lockdown system of FIG. 7 with the removable lockdown device installed.

FIG. 9 is a representation of the removable door lockdown system of FIG. 8 with the removable lockdown device installed and a user grasping a door handle; and

FIG. 10 depicts a close-up side view of the removable door lockdown system 4 of FIG. 9, illustrating a user pulling the door handle and the removable lockdown device preventing movement of the door.

### DESCRIPTION

The present disclosure relates to a double door lockdown system and a removable lockdown device for enhanced security in places such as commercial buildings (for example shopping malls, airports, office buildings, etc.), elementary and secondary schools, universities, churches, and the like. Each of these places typically use a double door configuration, and therefore present a unique challenge when it comes to security and safety. Double door lockdown system and removable lockdown device implementations are configured to provide ingress control to prevent a person, such as an active shooter, from entering the building, while also allowing for rapid and safe egress in case of fire, earthquake, or escaping to safety.

Detailed aspects and applications the present disclosure may be understood more readily by reference to the following detailed description and examples taken in connection with the accompanying drawings, which form a part of this disclosure.

For the purposes of explanation, numerous specific structural and functional details disclosed herein in order to provide a thorough understanding of the various aspects and applications of the disclosure. It will be understood, however, by those skilled in the relevant art, that implementations of the technology disclosed herein may be practiced without these specific details and that they are not to be interpreted as limits, but merely as a basis for teaching one skilled in the art to employ the present disclosure. The full scope of the disclosure herein is not limited to the examples that are described below. Specific examples enable the disclosure to be better understood. However, they are given merely by way of guidance and do not imply any limitation.

### Terminology and Definitions

In describing various implementations disclosed herein, the following terminology will be used in accordance with the definitions and explanations set out below. Notwithstanding, other terminology, definitions, and explanations may be found throughout this document as well. Unless specifically noted, it is intended that the words and phrases in the description and claims be given their plain, ordinary, and accustomed meaning to those of ordinary skill in the art.

As used herein, a “mullion” is a term used in its broadest sense and may refer to a vertical member that forms a division between units of a window, door, or screen or is used decoratively.

As used herein, a “set of double doors”, or a pair of double doors, is a term used in its broadest sense and may refer to side-by-side doors that fill a double-size doorway, hinged on the outside. The set of double doors typically includes two door panels within a door frame that may or may not be separated by a vertical mullion. Each door may be equal in width, or they may have different widths. The set of double doors comprises two doors which may be opened independently. The pair of double doors may be made of steel, wood, plastics, glass and other materials as known to those skilled in the art.

The singular forms “a,” “an,” and “the” include plural referents unless the context clearly dictates otherwise. Thus, for example, reference to “an element” or “a step” includes reference to one or more of such elements or steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner.

The words “comprise” and “contain” and variations of the words, for example “comprising” and “comprises”, mean “including but not limited to”, and are not intended to (and do not) exclude other components.

The term “plurality”, as used herein, means more than one.

All ranges are inclusive and combinable. When a range of values is expressed, another implementation includes from the one particular value and/or to the other particular value. Similarly, when values are expressed as approximations, by use of the antecedent “about,” it will be understood that the particular value forms another implementation.

### Detailed Description

In general, a removable lockdown device comprises a body and a set of stepped arms extending from the body. The body includes a top edge and a bottom edge. The first and second stepped arms extend from opposing ends of the bottom edge, respectively. Each stepped arm has a first section extending laterally outward from the body and a second section extending downwardly from a distal end of the first section.

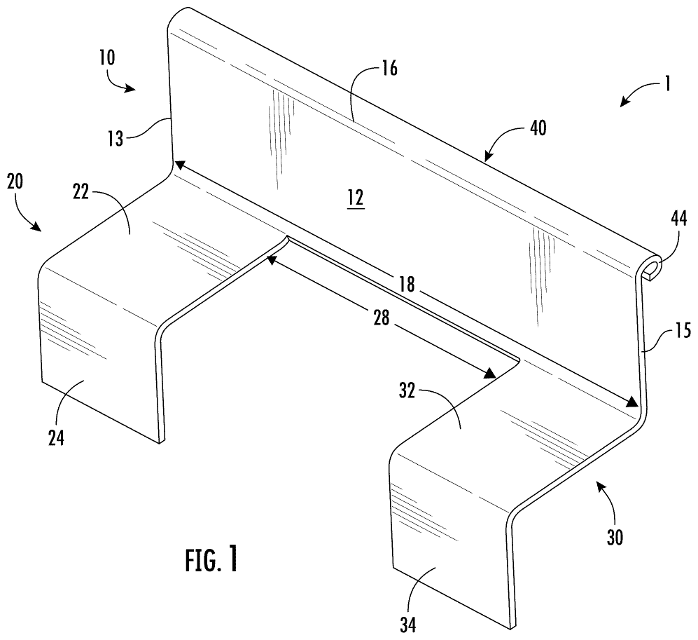

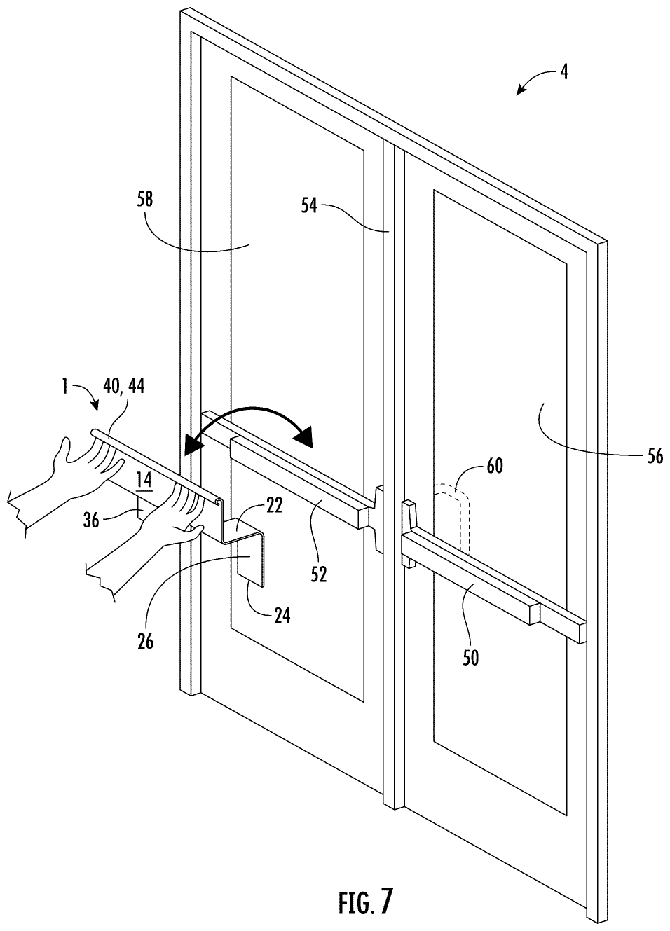

Referring to FIGS. 1-3, one implementation of a removable lockdown device 1 is depicted in a front perspective view, a back perspective view and a side cross section view. As seen in FIG. 1, the removable lockdown device 1 may be a generally U-shaped device and comprises a body 10, comprising a top edge 16 and a bottom edge 18, a first stepped arm 20, and a second stepped arm 30. A distance 28 between the first stepped arm 20 and the second stepped arm 30 may be adjusted to fit across a set of double doors, or a set of double doors including a mullion, as depicted in FIG. 7 following. Each of the first stepped arm 20 and the second stepped arm 30 extend outwardly from opposing ends of the bottom edge 18 of the body 10. The first stepped arm 20 and the second stepped arm 30 each comprise a first section, 22 and 32, respectively, extending outwardly at an angle from the body 10. In some implementations, the first and second stepped arms extend at an angle from the body 10 between about 45 degrees to about 90 degrees. In some implementations, the first and second stepped arms extend at an angle which is substantially perpendicular to the body 10. A person of ordinary skill would understand that the angle between the body 10 and the first and second stepped arms may vary according to the specific door exit devices employed in specific double door lockdown system implementations. The first stepped arm 20 and the second stepped arm 30 each further comprise a second section, 24 and 34, respectively, extending downwardly with respect to the body 10 and perpendicular to the first sections 22 and 32, respectively.

The removable lockdown device 1 may comprise at least one handle 40 disposed along at least a portion of the top edge 16 of the body 10. The handle 40 may comprise a tight c-channel 44 located opposite the first and second stepped arms 20 and 30, respectively, enabling a user to easily manipulate the door lockdown device 1. The tight c-channel handle 44, extending across at least a portion of the top edge 16, may provide increased strength to the removable lockdown device 1 and facilitate carrying the device.

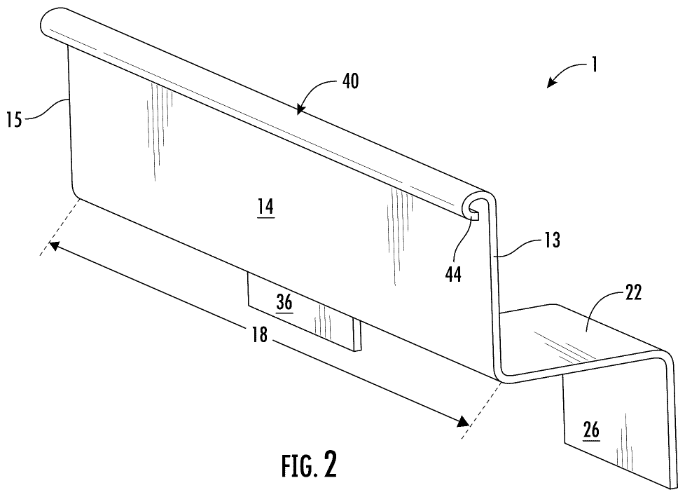

FIG. 2 illustrates the implementation of the removable lockdown device 1 of FIG. 1 in a back perspective view, showing a backside 14 of the body 10, having the c-channel handle 44 disposed thereon. FIG. 2 also illustrates first and second edges, 13 and 15, respectively, of the body 10, the first section 22 of the first stepped arm 20, a backside 26 of the second section 24 of the first stepped arm 20, and a backside 36 of the second section 34 of the second stepped arm 30. The first and second stepped arms, 20 and 30, respectively extend along bottom edge 18.

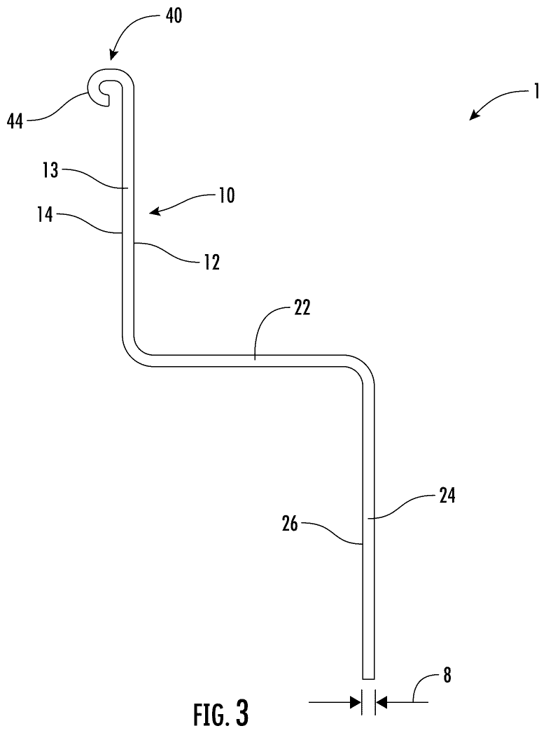

FIG. 3 shows a left side view of the implementation of the removable lockdown device 1 of FIG. 1 in cross-section, illustrating one implementation of the angular relationships between the body 10, the handle 40, the first section 22, and the second section 24. Backside 26 of the second section 24 is also shown. Further illustrated is a device thickness, 8.

### Additional Implementations

Many additional implementations are possible.

For the exemplary purposes of this disclosure, a removable lockdown device may comprise any number of handles 40 in a variety of configurations disposed along at least a portion of a top edge 16 of a body 10. A handle may have a curvilinear or rectilinear shape in cross-section.

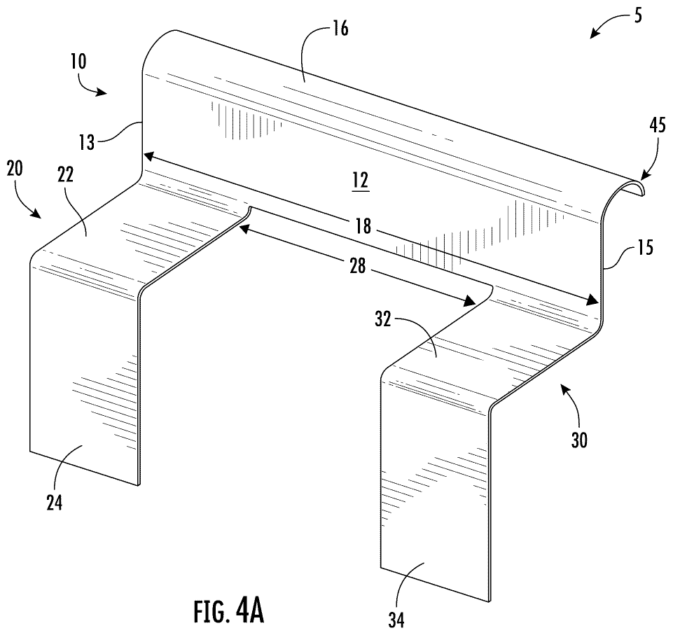

FIGS. 4A and 4B depict a front perspective view and a side view of removable lockdown device 5. Removable lockdown device 5 is similar to removable lockdown device 1, the principal difference being that the removable lockdown device 5 includes an open c-channel 45 having a larger radius of curvature such that a user may more easily grasp the device. The open c-channel 45, as with the tight c-channel 44, provides improved strength to the device while being easily manufactured. The removable lockdown device 5 may have second sections 24, 34 of first and second arms 20, 30 which are longer than first sections 22, 32, respectively, of first and second arms 20, 30.

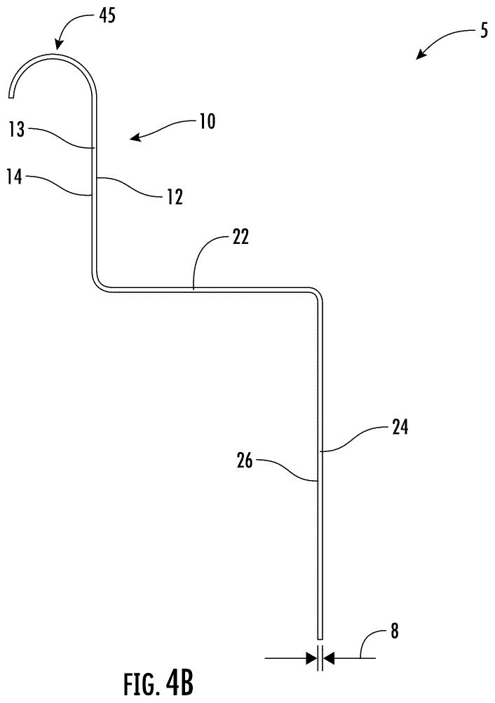

For the exemplary purposes of this disclosure, the removable lockdown device 2 of FIG. 5 shows a flat handle 46 which is substantially flat and extends outwardly from the top edge 16 at an angle (e.g., perpendicular to the body 10) and in a direction opposite to the first and second stepped arms, 20 and 30, respectively.

For the exemplary purposes of this disclosure, FIG. 5 depicts a front perspective view of removable lockdown device 2. Removable lockdown device 2 is similar to removable lockdown device 1, the principal difference being a plurality of perforations 11 disposed across the body 10 and across the first and second stepped arms, 20 and 30, respectively. While perforations 11 are depicted as circular, it is understood that any curvilinear or rectilinear shape of perforation may be used to facilitate ease of manufacturing or to reduce weight of the device. Additionally, any configuration of perforations, such as a small number of large perforations, a large number of small perforations, or locations of perforations or groupings of perforations for example, are contemplated while maintaining the necessary structural integrity and mechanical strength of the removable lockdown device 2. For example, the perforations may be disposed across the body, on one or both of the first and second stepped arms, on the handle, and the like, dependent upon design considerations. In some implementations, the removable lockdown device 2 comprises a plurality of lightening holes to reduce the overall weight of the device. In implementations where the removable lockdown device 2 is formed from a sheet of metal, the perforation may be formed by stretching the metal into a hole, thereby increasing the material strength in the region surrounding the perforation.

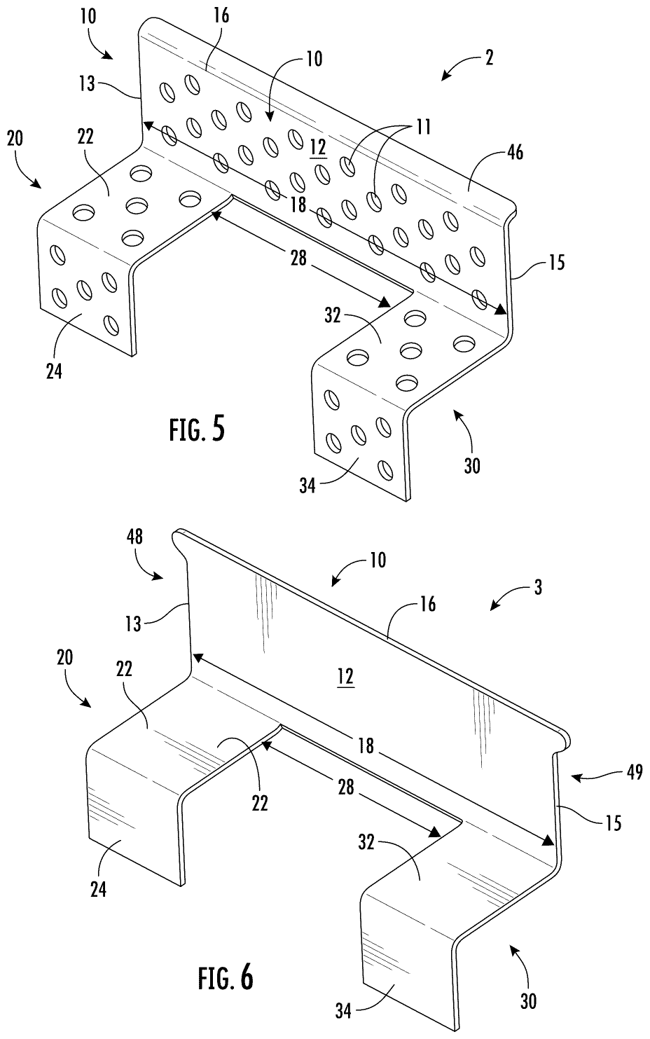

Now referring to FIG. 6, a front perspective view is shown of a further implementation of a removable lockdown device 3. Removable lockdown device 3 is similar to removable lockdown device 1, the principal difference being the removable lockdown device 3 having a body 10 with a first handle 48 disposed along at least a portion of a first edge 13 of the body 10, and a second handle 49 disposed along at least a portion of a second edge 15 of the body 10, where the handles 48, 49 are formed by a linear (as shown) or non-linear cut away to facilitate gripping the removable lockdown device by the side edges 13, 15 of the body 10. According to some implementations, at least a portion of the first handle 48 and second handle 49 may extend outwardly beyond the linear or non-linear cut away.

In some implementations, in order to increase strength, at least a portion of an edge of a removable lockdown device may include wire edges or hemmed edges along any of the sides. For example, any portion of edges 13, 15, 16, 18 of a body 10 or stepped arms 20, 30 can be a wired or hemmed edge.

While detailed removable lockdown device implementations of the present disclosure are included herein, it is to be understood that the disclosed implementations are merely exemplary of the disclosed technology that may be embodied in various forms. In places where the description refers to particular removable lockdown device implementations, it should be readily apparent that a number of modifications may be made without departing from the spirit thereof and that these modifications may be applied to other implementations disclosed or undisclosed. Any of the implementations shown or discussed in this disclosure may be combined in different ways to fit the needs of a particular situation. Thus, the presently disclosed removable lockdown devices are to be considered in all respects as illustrative and not restrictive.

Further implementations are within the claims.

### Materials, Manufacture, and Assembly

It will also be understood that implementations of the removable lockdown device include but are not limited to the specific components disclosed herein, as virtually any components consistent with the intended operation of a removable lockdown device may be utilized. Accordingly, for example, it should be understood that, while the drawings and detailed description show and describe particular removable lockdown device implementations, any such implementation may comprise components of any shape, size, style, type, model, version, class, grade, measurement, concentration, material, weight, quantity, and/or the like consistent with the intended operation of a removable lockdown device.

It is contemplated that the components included in removable lockdown device implementations may be formed of any of many different types of materials or combinations that can readily be formed into shaped objects and that are consistent with the intended operation of a removable lockdown device. For example, a removable lockdown device may be formed of: rubbers (synthetic and/or natural) and/or other like materials; glasses (such as fiberglass), carbon-fiber, aramid-fiber, any combination therefore, any composites thereof, and/or other like materials; elastomers and/or other like materials; polymers such as thermoplastics (such as ABS, fluoropolymers, polyacetal, polyamide, polycarbonate, polyethylene, polysulfone, and/or the like, thermosets (such as epoxy, phenolic resin, polyimide, polyurethane, and/or the like), Kevlar™, and/or other like materials; plastics and/or other like materials; various types of wood, wood-based composites, and/or other like materials; metals, such as zinc, magnesium, titanium, copper, iron, steel, carbon steel, alloy steel, tool steel, stainless steel, spring steel, aluminum, and/or other like materials; and/or any combination of the foregoing.

In some implementations, the particular materials forming the components, and the design of the removable lockdown device, may be selected to minimize the weight of the device for ease of device removal and installation. For example, a lightweight yet strong material such as aluminum or an aluminum alloy, having a particular thickness may be selected for use. In some implementations, the removable lockdown device may have a thickness of from about 0.0625 inches to about 0.125 inches, or from about 0.068 inches to about 0.090 inches. In some implementations, the removable lockdown device may have a thickness of about 0.080 inches.

Removable lockdown devices may be manufactured in various different manners and from varying materials. A removable lockdown device may be manufactured separately and then assembled together, or any or all of the components of the removable lockdown device may be manufactured simultaneously and integrally joined with one another. Manufacture of these components separately or simultaneously may involve 3-D printing, extrusion, pultrusion, vacuum forming, injection molding, blow molding, resin transfer molding, casting, forging, cold rolling, milling, drilling, reaming, turning, grinding, stamping, forming, cutting, bending, welding, soldering, hardening, riveting, punching, plating, and/or the like. If any of the components are manufactured separately, they may then be coupled or removably coupled with one another in any manner, such as with adhesive, a weld, a fastener, a hinge, a braze, any combination thereof, and/or the like for example, depending on, among other considerations, the particular material(s) forming the components.

In some implementations, a removable lockdown device comprises a unitary device which is formed from a single piece, such as from a stamped and formed sheet of metal. This provides a manufacturable, cost effective method for producing the device from a wide array of materials, such as sheet metals or alloys for example.

### Systems and Methods of Use

The present disclosure is also related to methods of use of the removable lockdown device as part of a system for prevention of unwanted ingress. The lockdown system provides a removable lockdown device which may be easily accessed by people of all heights, people that are handicapped or have special needs, and the like for easy installation or removal. Lockdown system and removable lockdown device implementations are particularly useful in commercial buildings, for example shopping malls, airports, office buildings, schools, universities, buildings for the practice of religion, financial institutions, airports, stadiums, and the like. However, implementations are not limited to uses relating to these facilities. Rather, any description relating to the prevention of unauthorized ingress in these facilities is for the exemplary purposes of this disclosure, and implementations may also be used in a variety of other facilities and applications with similar results.

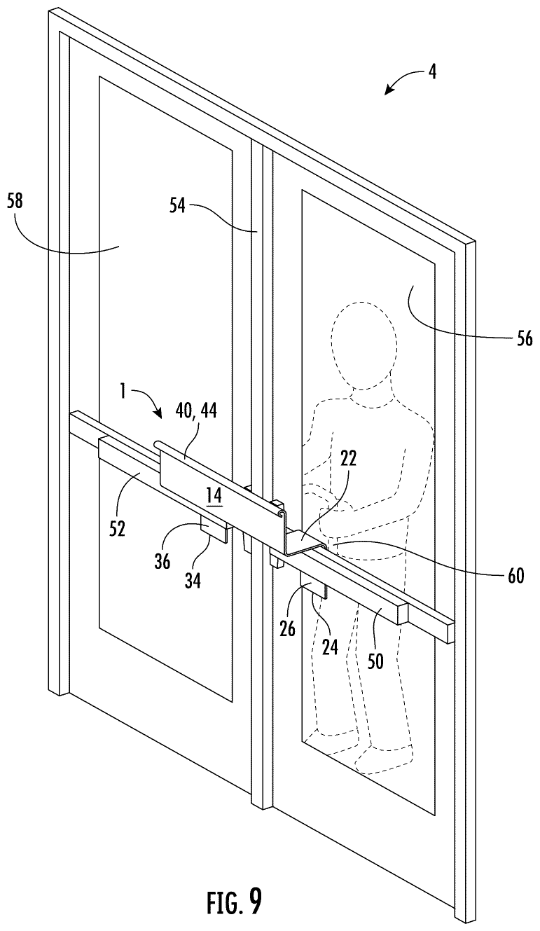

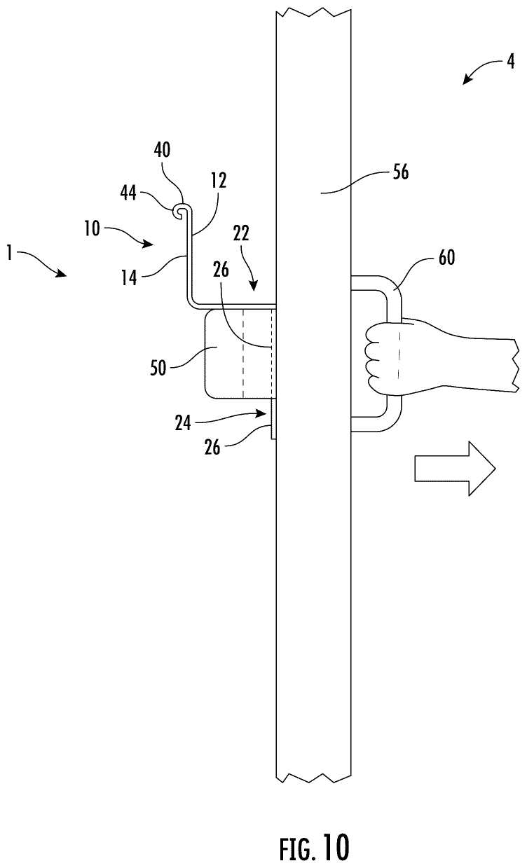

Implementations of the removable lockdown devices as disclosed herein may be included as one part of a double door lockdown system, such as double door lockdown system 4 as depicted in FIG. 7 for example. The double door lockdown system 4 includes a first door 56 and a second door 58, comprising a set of double doors, each door having at least one door handle 60 (as shown in FIGS. 9 and 10) disposed on an exterior surface for opening the doors from the outside of the building.

The set of double doors may include a first exit device 50 disposed horizontally across, and on the inside of, a first door 56 of the set of double doors, and a second exit device 52 disposed horizontally across, and on the inside of, a second door 58 of the set of double doors. The first and second exit devices, 50 and 52, respectively, may comprise any one of a panic bar, a push bar, a touch bar, a cross bar, a crash bar, or an integral device that are typically used in double door configurations where rapid egress is desired. The first and second exit devices 50 and 52, respectively, for providing rapid egress may be referred to synonymously by a number of other names. The first and second exit devices are typically disposed horizontally across, and on the inside of, each door of the set of double doors such that there exists a space between a backside of each of the first and second exit devices and the inside of the first and second doors, respectively, of the set of double doors.

In some implementations and as shown in the implementation of FIG. 7, the double door lockdown system 4 may include a mullion 54 disposed vertically between the set of double doors. Use of a mullion provides additional structural support to the set of double doors. The mullion may comprise a fixed mullion, i.e., comprising an integral part of the frame between the set of double doors, or a removable mullion, which may be removed through use of an appropriate tool to allow for passage of equipment, furniture and the like through the door frame. As shown in FIG. 7, a user is depicted carrying one implementation of the removable lockdown device 1 for installation on or removal from, the set of double doors 56 and 58, as shown in FIG. 7.

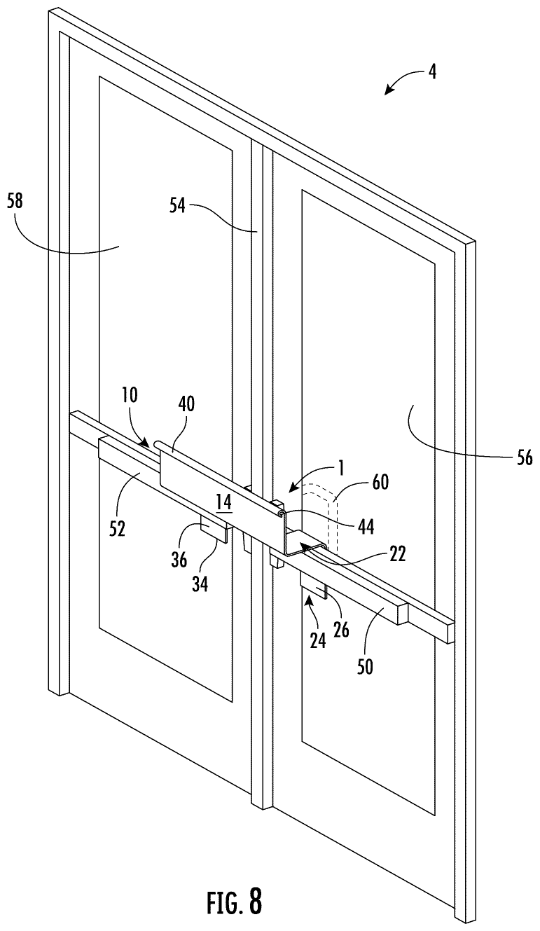

With reference to FIG. 8, illustrated is the double door lockdown system 4 showing the removable lockdown device 1 implementation of FIG. 1 in an as-installed configuration, depicting the body 10 extending between the first exit device 50 and the second exit device 52. FIG. 8 further depicts the first section 22 of the first stepped arm 20 removably positioned atop the first exit device 50, and the backside 26 of the second section 24 of the first stepped arm 20 removably positioned between the first exit device 50 and the inside of the first door 56. With respect to the second stepped arm 30, the first section 32 of the second stepped arm 30 is likewise removably positioned atop the second exit device 52, and the backside 36 of the second section 34 of the second stepped arm 30 likewise removably positioned between the second exit device 52 and the inside of the second door 58. When the removable lockdown device 1 is in the as-installed configuration, a user is prevented from opening either of the first and second doors, 56 and 58, respectively, as shown in FIGS. 9-10.

According to FIG. 9, a person may be viewed as trying to open either of the first and second doors, 56 and 58, respectively, whose entry is prevented by the removable lockdown device 1 in the as-installed configuration. While the implementation of FIG. 9 is illustrated with a user visible, a person of ordinary skill in the art would understand that the functionality would remain the same when the set of double doors comprises a door made of a material which is not transparent.

In the side view of the double door lockdown system 4 as shown in FIG. 10, a hand of a user may be seen pulling door handle 60 when attempting to open first door 56 or second door 58. When at least one of the first and second doors, 56 and 58, respectively, are pulled outwardly (as shown by the arrow of FIG. 10) using the door handle 60, at least one of the first and second exit devices (50 and 52, respectively) applies a force to at least one backside (26 and 36, respectively) of the second sections (24 and 34, respectively) of the first and second stepped arms (20 and 30, respectively). The force applied to at least one of the backsides (26 and 36, respectively) moves the front side 12 of the main body 10 adjacent to and pressing against the mullion 54. In so doing, the body 10 of the removable lockdown device prevents the opening of either of the first double door 56 or the second double door 58.

While the double door lockdown system 4 is depicted including removable lockdown device 1 as part of the system 4, it is understood that any of the implementations of removable lockdown devices disclosed herein may be included as part of the double door lockdown system 4.

1. A double door lockdown system comprising:
a set of double doors, each door having a door handle disposed on an outside thereof;
a first exit device disposed horizontally across a first door of the set, and a second exit device disposed horizontally across a second door of the set, wherein the first and second exit devices are disposed on an inside of the first and the second doors, respectively; and
a removable lockdown device configured to prevent the set of double doors from opening, the removable lockdown device comprising:
a body comprising a top edge and a bottom edge; and
a first stepped arm and a second stepped arm extending from opposing ends of the bottom edge, respectively, each stepped arm having a first section extending laterally outward from the body, and a second section extending downwardly from a distal end of the first section;
wherein the body extends between the first exit device and the second exit device with the first section of the first stepped arm removably positioned atop the first exit device, the second section of the first stepped arm removably positioned between the first exit device and the inside of the first door, the first section of the second stepped arm removably positioned atop the second exit device, and the second section of the second stepped arm removably positioned between the second exit device and the inside of the second door.

2. The double door lockdown system of claim 1 further comprising a fixed or removable mullion disposed between the double doors.

3. The double door lockdown system of claim 1, wherein the first and second exit devices comprise any one of a panic bar, a push bar, a touch bar, or a crash bar.

4. The double door lockdown system of claim 1, wherein the first stepped arm and the second stepped arm extend from opposing ends of the bottom edge perpendicular to the body.

5. The double door lockdown system of claim 1, wherein the lockdown device further comprises at least one handle disposed along at least a portion of the top edge of the body.

6. The double door lockdown system of claim 5, wherein the at least one handle has a curvilinear or rectilinear shape in cross-section.

7. The double door lockdown system of claim 1, wherein the body, the first stepped arm, and the second stepped arm comprise a single piece.

8. A removable lockdown device configured to prevent a set of double doors from opening, the removable lockdown device comprising:
a body comprising a top edge and a bottom edge, the top edge comprising at least one handle disposed along at least a portion of the top edge; and
a first stepped arm and a second stepped arm, the first and second stepped arms extending from opposing ends of the bottom edge, respectively, each stepped arm having a first section extending laterally outward from the body, and a second section extending downwardly from a distal end of the first section.

9. The removable lockdown device of claim 8, wherein the first stepped arm and the second stepped arm extend from opposing ends of the bottom edge perpendicular to the body.

10. The removable lockdown device of claim 8, wherein the at least one handle has a curvilinear or rectilinear shape in cross-section.

11. The removable lockdown device of claim 9, wherein the at least one handle comprises a c-channel handle extending from the top edge in a direction opposite the first and second stepped arms.

12. The removable lockdown device of claim 9, wherein the at least one handle comprises a flat handle extending from the top edge in a direction opposite the first and second stepped arms.

13. The removable lockdown device of claim 8, wherein the body, the first stepped arm, and the second stepped arm comprise a single piece.

14. A removable lockdown device configured to prevent a set of double doors from opening, the removable lock down device comprising:
a body comprising a top edge and a bottom edge; and
a first stepped arm and a second stepped arm, the first and second stepped arms extending from opposing ends of the bottom edge, respectively, each stepped arm having a first section extending laterally outward from the body, and a second section extending downwardly from a distal end of the first section.

15. The removable lockdown device of claim 14, wherein the first stepped arm and the second stepped arm extend from opposing ends of the bottom edge perpendicular to the body.

16. The removable lockdown device of claim 14 further comprising at least one handle disposed along at least a portion of the top edge of the body.

17. The removable lockdown device of claim 16, wherein the at least one handle has a curvilinear or rectilinear shape in cross-section.

18. The removable lockdown device of claim 17, wherein the at least one handle comprises a c-channel handle extending from the top edge in a direction opposite the first and second stepped arms.

19. The removable lockdown device of claim 17, wherein the at least one handle comprises a flat handle extending from the top edge in a direction opposite the first and second stepped arms.

20. The removable lockdown device of claim 16, wherein the body, the first stepped arm, and the second stepped arm comprise a single piece.
